(19) United States
(12) Patent Application Publication
(10) Pub. No.: US 2026/0369460 A1
(43) Pub. Date: Nov. 19, 2026

(54) COIL DEVICE

(71) Applicant: TDK CORPORATION, Tokyo (JP)

(72) Inventors: Tomoya ISHIHARA, Tokyo (JP); Toru TONOGAI, Tokyo (JP)

(73) Assignee: TDK CORPORATION, Tokyo (JP)

(21) Appl. No.: 19/675,028

(22) Filed: May 12, 2026

(30) Foreign Application Priority Data
May 15, 2025 (JP) 2025-082093

(51) Int. Cl. H01F 27/28; H01F 27/29; H01F 27/30; H01F 27/32

(52) U.S. Cl. CPC H01F 27/2847; H01F 27/292; H01F 27/306; H01F 27/324; H01F 2027/2861

(57) ABSTRACT

A coil device, including: an element body containing a magnetic material and a resin, and having a mounting surface; and a conductor including a winding part embedded in the element body, and a terminal provided at an end of the winding part and extending along the mounting surface; wherein the terminal has a maximum thickness at a distal end side positioned away from a proximal end of the terminal in a cross section perpendicular to the mounting surface and an extending direction of the terminal.

### CROSS-REFERENCE TO RELATED APPLICATIONS

Priority is claimed on Japanese Patent Application No. 2025-082093, filed on May 15th, 2025, the entire content of which is incorporated herein by reference.

### BACKGROUND

The present disclosure relates to a coil device.

For example, a coil device disclosed in Patent Document 1 includes a conductor and an element body containing a magnetic material and covering the conductor. The conductor includes a winding part embedded in the element body, and a terminal provided at an end of the winding part and extending along a mounting surface. The terminal is partially exposed from the mounting surface, and the terminal has a configuration which can connect to a land pattern of a circuit board.

In this type of coil device, when the coupling between the conductor and the element body is weak, the conductor may separate from the element body, and a desired magnetic property may not be attained. Therefore, there has been a demand for a coil device capable of preventing the release of the conductor from the element body.

### PRIOR ART DOCUMENT

### Patent Document

[Patent Document 1] Patent Document 1: JP Patent Application No. 2022-066107 A

### SUMMARY

A coil device according to one embodiment of the present disclosure, includes: an element body containing a magnetic material and a resin, and having a mounting surface; and a conductor including a winding part embedded in the element body, and a terminal provided at an end of the winding part and extending along the mounting surface; wherein the terminal has a maximum thickness at a distal end side positioned away from a proximal end of the terminal in a cross section perpendicular to the mounting surface and an extending direction of the terminal.

### BRIEF DESCRIPTION OF DRAWINGS

FIG. 1 is a perspective view illustrating one example of a coil device according to one embodiment of the present disclosure.

FIG. 2 is a cross-sectional view of the coil device illustrated in FIG. 1, taken along a line II-II.

FIG. 3 is a partially enlarged cross-sectional view of a first terminal illustrated in FIG. 2.

FIG. 4A is a partially enlarged cross-sectional view showing a modification example of the coil device illustrated in FIG. 1.

FIG. 4B is a partially enlarged cross-sectional view showing a modification example of the coil device illustrated in FIG. 1.

FIG. 4C is a partially enlarged cross-sectional view showing a modification example of the coil device illustrated in FIG. 1.

FIG. 5A is a perspective view showing a modification example of the coil device illustrated in FIG. 1.

FIG. 5B is a perspective view showing a modification example of the coil device illustrated in FIG. 1.

### DETAILED DESCRIPTION

Hereinafter, an embodiment of the present disclosure will be described with reference to the drawings. The contents illustrated in the drawings are merely schematic examples for better understanding of the present disclosure, and the appearance, dimensional ratios, or the like may not be precisely the same as the actual ones. In addition, the present disclosure is not limited to the following embodiment.

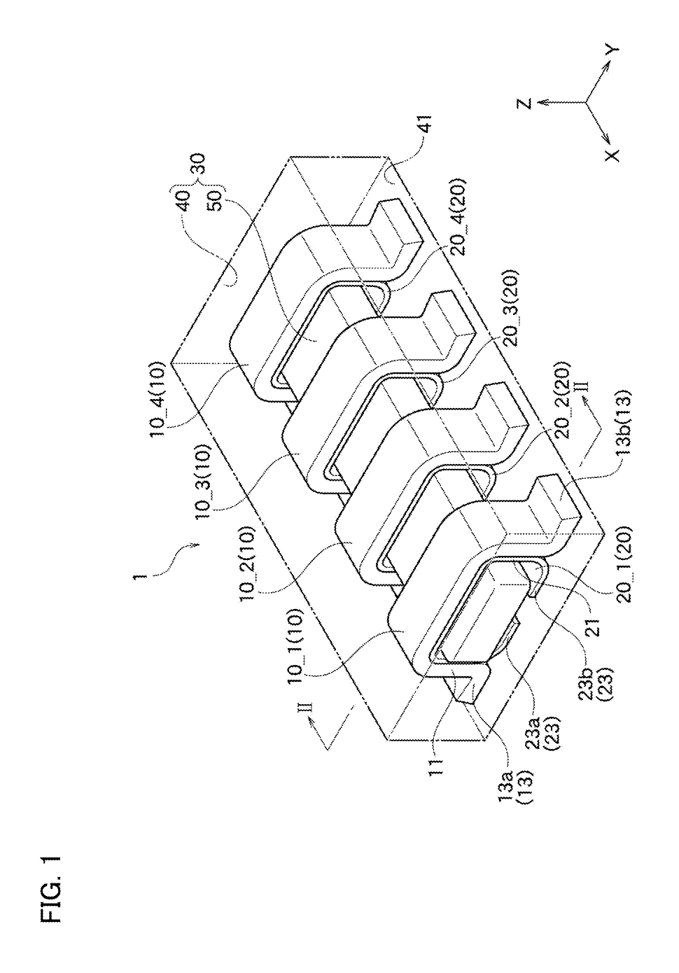

A coil device 1 according to one embodiment of the present disclosure illustrated in FIG. 1 is a magnetically coupled coil device, and is mounted on power supplies or the like of various electrical devices. The coil device 1 includes first conductors 10_1 to 10_4, second conductors 20_1 to 20_4, and an element body 30. Hereinafter, unless otherwise distinguished, the first conductors 10_1 to 10_4 are collectively referred to as a “first conductor 10”. In addition, unless otherwise distinguished, the second conductors 20_1 to 20_4 are collectively referred to as a “second conductor 20”.

The element body 30 is formed of a composite material containing a magnetic material, and partially covers each of the first conductor 10 and the second conductor 20. The element body 30 includes an outer core 40 and an inner core 50.

The outer core 40 contains a magnetic material and a resin. The outer core 40 is molded by various molding techniques such as resin molding, transfer molding, injection molding, and dry molding. The inner core 50 contains a magnetic material but does not contain a resin. However, in another embodiment, the inner core 50 may contain a resin in addition to a magnetic material. The inner core 50 is molded by various molding techniques such as sintering.

The magnetic material constituting the element body 30 is not particularly limited, and for example, the magnetic material may be ferrite or a metallic magnetic material. Examples of the ferrite include Ni-Zn-based ferrite and Mn-Zn-based ferrite. Examples of the metallic magnetic material include Fe-Ni alloy powder, Fe-Si alloy powder, Fe-Si-Cr alloy powder, Fe-Co alloy powder, Fe-Si-Al alloy powder, and amorphous iron. The resin constituting the element body 30 is not particularly limited, and for example, the resin may be an epoxy resin, a phenol resin, a polyester resin, a polyurethane resin, or a polyimide resin.

The outer core 40 has a mounting surface 41. The mounting surface 41 is a surface opposite to a mounting substrate (not illustrated) which is for mounting the coil device 1. Here, in FIG. 1 and the like, the Z-axis is an axis perpendicular to the mounting surface 41. The X-axis is, for example, an axis along the winding axis direction of a first winding part 11 of the first conductor 10. The Y-axis is, for example, an axis along the extending direction of a first terminal part 13a or 13b of the first conductor 10. The X-axis, the Y-axis, and the Z-axis are perpendicular to each other.

Hereinafter, the positive direction of the Z-axis is defined as upward, and the negative direction of the Z-axis is defined as downward.

In the present disclosure, the term “perpendicular” does not necessarily refer to strictly perpendicular orientation. It also includes an orientation having a deviation of ±Δθ° or less (where Δθ is, for example, 3, although not particularly limited) relative to the strictly perpendicular orientation. In addition, the term "parallel" does not necessarily refer to a strictly parallel orientation. It also includes an orientation having a deviation of ±Δθ° or less (where Δθ is, for example, 3, although not particularly limited) relative to the strictly parallel orientation.

The length of the element body 30 in an X-axis direction is not particularly limited, and for example, it may be 3.0 mm to 40.0 mm. The length of the element body 30 in a Y-axis direction is not particularly limited, and for example, it may be 3.0 mm to 20.0 mm. The length of the element body 30 in a Z-axis direction is not particularly limited, and for example, it may be 1.0 mm to 30.0 mm.

The external shape of the element body 30 is a hexahedron (rectangular parallelepiped); however, it may be any other polyhedron such as an octahedron, or a columnar shape such as a circular columnar shape. In the present disclosure, examples of the columnar shape also include a three-dimensional shape in which surfaces opposite to each other in the Z-axis direction are not congruent, such as a truncated cone shape.

The inner core 50 is disposed inside a second winding part 21 of each of the second conductors 20_1 to 20_4, and penetrates through the interior of the second winding part 21 of each of the second conductors 20_1 to 20_4. The external shape of the inner core 50 is substantially a hexahedron, but it may be any other polyhedron such as an octahedron. In the example illustrated in FIG. 1, in a cross section perpendicular to the winding axis direction of the second winding portion 21, the shape of an outer circumference surface of the inner core 50 is substantially rectangular.

The material constituting the inner core 50 may be the same as the material constituting the outer core 40 or may be different from the material constituting the outer core 40. A part of the outer circumference surface of the inner core 50 may be bonded to an inner circumference surface of the second conductor 20.

The first conductor 10 is configured of a plate-shaped conductor, and includes the first winding part 11 and a pair of the first terminals 13a and 13b, which are continuous with both ends of the first winding part 11. Hereinafter, unless otherwise distinguished, the first terminals 13a and 13b are collectively referred to as a “first terminal 13”.

The first conductor 10 is configured of, for example, a machined metal plate.

The material constituting the first conductor 10 is not particularly limited, and examples of the material include metals such as copper, a copper alloy, silver, and nickel. A thickness of the first conductor 10 (the length between an inner circumference surface and an outer circumference surface of the first conductor 10) is not particularly limited, and for example, it may be 0.1 mm to 2.5 mm. A width (here, the width in the X-axis direction) of the first conductor 10 is not particularly limited, and for example, it may be 0.2 mm to 10 mm. When the coil device 1 is used as a coupled inductor, the first conductor 10 functions as, for example, a primary conductor.

The first winding part 11 is embedded in the outer core 40. The first winding part 11 is curved in a C-like shape or a U-like shape, and the number of turns of the first winding part 11 is less than one turn. The winding axis direction of the first winding part 11 corresponds to the X-axis direction. The maximum length of the first winding part 11 in the Y-axis direction is larger than the height of the first winding part 11, but the maximum length may be equal to or less than the height of the first winding portion 11.

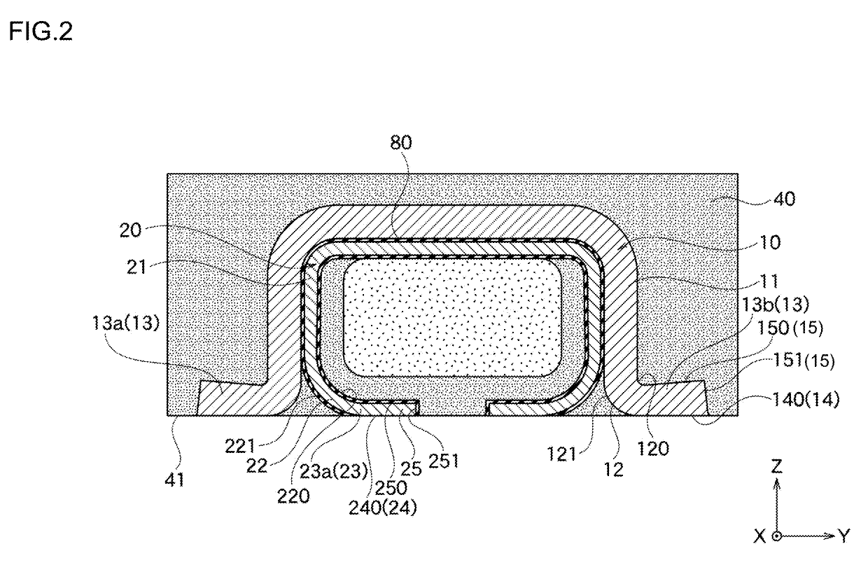

As illustrated in FIG. 2, the first winding part 11 includes a first curved part 12 curved so as to be continuous with the first terminal 13. In the example shown in FIG. 2, the radius of curvature of an inner circumference surface 120 of the first curved part 12 is smaller than the radius of curvature of an outer circumference surface 121 of the first curved part 12.

The first terminal 13 functions as a terminal electrode for electrically connecting the first conductor 10 to the land pattern of the mounting substrate (not illustrated). The first terminal 13 may be connected to the land pattern of the mounting substrate by, for example, a solder or a conductive adhesive. The first terminals 13a and 13b are provided at both end parts of the first winding part 11, and extend along the mounting surface 41 in directions away from each other.

The first terminal 13 includes an exposed part 14 and an embedded part 15. The exposed part 14 is exposed from the mounting surface 41, and the embedded part 15 is embedded in the outer core 40. The exposed part 14 has an exposed surface 140 exposed from the mounting surface 41. The exposed surface 140 extends along the mounting surface 41. The exposed part 14 may protrude downward from the mounting surface 41. The embedded part 15 has an embedded surface 150 and a distal end surface 151 that are embedded in the outer core 40. The embedded surface 150 is a surface which is opposite to the exposed surface 140. The distal end surface 151 is located at a distal end of the first terminal 13, and connects the exposed surface 140 and the embedded surface 150.

As illustrated in FIG. 1, the second conductor 20 is provided inside the first conductor 10. The second conductor 20 is configured of a plate-shaped conductor, and includes the second winding part 21 and a pair of second terminals 23a and 23b, which are continuous with both ends of the second winding part 21. Hereinafter, unless otherwise distinguished, the second terminals 23a and 23b are collectively referred to as a “second terminal 23”.

The second conductor 20 may be configured, for example, of a machined metal plate. The material configuring the second conductor is the same as the material configuring the first conductor 10; however, it may be different from the material configuring the first conductor 10. A thickness of the second conductor 20 (a length between the inner circumference surface and the outer circumference surface of the second conductor 20) is not particularly limited, and it may be 0.1 to 1 mm. A width of the second conductor 20 (a width along the X-axis direction) is not particularly limited; and for example, it may be 0.2 mm to 5 mm. When the coil device 1 is used as a coupled inductor, the second conductor 20 functions as, for example, a secondary conductor.

The second winding part 21 is embedded in the outer core 40. The second winding part 21 is curved in a C-like shape or a U-like shape, and the number of turns of the second winding part 21 is less than one turn. The winding axis direction of the second winding part 21 corresponds to the X-axis direction. The maximum length of the second winding part 21 in the Y-axis direction is larger than the height of the second winding part 21, but it may be equal to or less than the height of the second winding part 21.

As shown in FIG. 2, the second winding part 21 includes a second curved part 22 curved so as to be continuous with the second terminal 23. In the example shown in FIG. 2, the radius of curvature of an inner peripheral surface 220 of the second curved part 22 is smaller than the radius of curvature of an outer peripheral surface 221 of the second curved part 22. Also, the radius of curvature of the outer circumference surface 221 of the second curved part 22 is larger than the radius of curvature of the outer circumference surface 121 of the first curved part 12.

The second terminal 23 functions as a terminal electrode for electrically connecting the second conductor 20 to the land pattern of the mounting substrate (not illustrated). The second terminal 23 may be connected to the land pattern of the mounting substrate by, for example, a solder or a conductive adhesive. The second terminals 23a and 23b are provided at both ends of the second winding part 21, and extend along the mounting surface 41 in directions toward each other.

As shown in FIG. 2, the second terminal 23 includes an exposed part 24 and an embedded part 25. The exposed part 24 is exposed from the mounting surface 41, and the embedded part 25 is embedded in the outer core 40. The exposed part 24 has an exposed surface 240 exposed from the mounting surface 41. The exposed surface 240 extends along the mounting surface 41. The exposed part 24 may protrude downward from the mounting surface 41. The embedded part 25 includes an embedded surface 250 and a distal end surface 251 that are embedded in the outer core 40. The embedded surface 250 is a surface which is opposite to the exposed surface 240. The distal end surface 251 is located at a distal end of the second terminal 23, and connects the exposed surface 240 and the embedded surface 250.

As shown in FIG. 2, at least one of the first conductor 10 and the second conductor 20 has an insulating layer 80 covering the surface of at least one of the first conductor 10 and the second conductor 20. In the present embodiment, the second conductor 20 has the insulating layer 80 covering the surface of the second conductor 20. The first conductor 10 does not have the insulating layer 80; however, the first conductor 10 may have the insulating layer 80 covering the surface of the first conductor 10. The material constituting the insulating layer 80 is not particularly limited, and examples include polyester, polyesterimide, polyamide, polyamideimide, polyurethane, epoxy, and an epoxy-modified acrylic resin.

The insulating layer 80 at least partially covers the second winding part 21 (in the present embodiment, the second winding part is entirely covered). The first conductor 10 and the second conductor 20 can be insulated from each other by the insulating layer 80. In addition, the insulating layer 80 partially covers the second terminal 23. For the exposed surface 240 of the second terminal 23 that contributes to the connection with the land pattern of the mounting substrate, the insulation layer 80 is not applied.

In the cross section perpendicular to the mounting surface 41 and the extending direction of the first terminal 13 (hereinafter, such cross section may be referred to as “ZY cross-section”), the first terminal 13 has the maximum thickness at the distal end side which is a position away from the proximal end of the first terminal 13. Here, the proximal end of the first terminal 13 is a boundary area positioned between the first terminal 13 and the first winding part 11. Also, the proximal end of the first terminal 13 is an opposite end relative to the distal end of the first terminal 13. In the present embodiment, the first terminal 13 in the ZY cross-section has the maximum thickness at the distal end side which is the furthest from the proximal end of the first terminal 13; i.e., the first terminal 13 has the maximum thickness at the distal end (at the position of the distal end surface 151).

As the example shown in FIG. 2 illustrates, in the ZY cross-section, each of the first terminals 13a and 13b has the maximum thickness at the distal end side which is a position away from the proximal end of each of the first terminals 13a and 13b. Either one of the first terminals 13a and 13b in the ZY cross-section may have the maximum thickness at the distal end side which is at a position away from either one of the first terminals 13a and 13b.

In the ZY cross-section, the thickness of the first terminal 13 gradually increases towards the distal end of the first terminal 13. That is, the first terminal 13 becomes thicker from the proximal end to the distal end of the first terminal 13; i.e., becomes thicker towards the distal end of the first terminal 13. Note that, the first terminal 13 may gradually become thicker in a part of the area between the proximal end and the distal end of the first terminal 13.

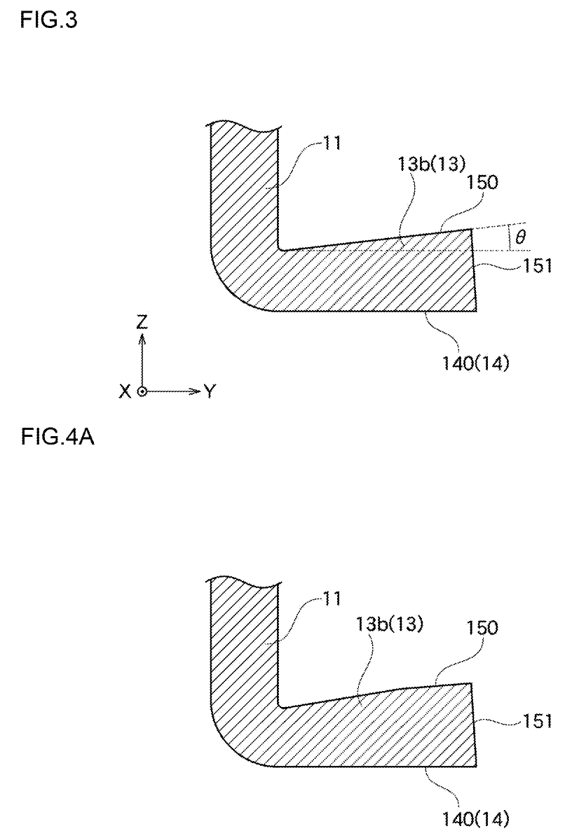

The embedded surface 150 is a slanted surface which is slanted with respect to the exposed surface 140. The embedded surface 150 is slanted with respect to the exposed surface 140 such that a distance between the embedded surface 150 and the exposed surface 140 widens towards the distal end of the first terminal 13. As shown in FIG. 3, a slanted angle θ of the embedded surface 150 with respect to the exposed surface 140 is not particularly limited, and it may be 0° ≤ θ ≤ 30°, or may be 5° ≤ θ ≤ 20°. Note that, the exposed surface 140 is parallel to the XY plane.

As shown in FIG. 2, in the ZY cross-section, the embedded surface 150 is a flat surface. However, at least part of the embedded surface 150 may be a curved surface or an uneven surface.

The embedded surface 150 is slanted with respect to the exposed surface 140 from the proximal end towards the distal end of the first terminal 13. However, the embedded surface 150 may be slanted with respect to the exposed surface 140 in a part of the area from the proximal end to the distal end of the first terminal 13.

In the ZY cross-section, the distal end surface 151 of the first terminal 13 is a slanted surface which is slanted with respect to the exposed surface 140 or the mounting surface 41. That is, in the ZY cross-section, the distal end surface 151 is slanted with respect to the exposed surface 140 or the mounting surface 41 so that the angle between the distal end surface 151 and the exposed surface 140 is an acute angle. Note that, in the ZY cross-section, the distal end surface 151 may be perpendicular to the exposed surface 140 or the mounting surface 41. Alternatively, in the ZY cross-section, the distal end surface 151 is slanted with respect to the exposed surface 140 or the mounting surface 41 so that the angle between the distal end surface 151 and the exposed surface 140 is an obtuse angle.

As the example shown in FIG. 2 illustrates, in the ZY cross-section, the distal end surface 151 is a flat surface. However, at least part of the distal end surface 151 may be a curved surface or an uneven surface.

Next, a method for manufacturing the coil device 1 will be described with reference to FIG. 1. First, the first conductor 10, the second conductor 20, and the inner core 50 molded in advance, which are shown in FIG. 1, are prepared. The first conductor 10 as shown in FIG. 1 is, for example, obtained by machining the conductor so that the first terminal 13 has the maximum thickness at the distal end side which is positioned away from the proximal end of the first terminal 13.

Next, the second conductor 20 is superimposed on the first conductor 10 so that the second conductor 20 is disposed inside the first conductor 10. If necessary, at least part of the outer circumference surface of the second winding part 21 is adhered on the inner circumference surface of the first winding part 11. In addition, the inner core 50 is inserted into the interior of each of the second conductors 20_1 to 20_4 so as to penetrate the interior of each of the second conductors 20_1 to 20_4. If necessary, at least part of the inner circumference surface of the second winding part 21 is adhered on the outer circumference surface of the inner core 50.

Next, the first conductor 10 and the second conductor 20 in a pair, to which the inner core 50 is mounted, are mounted in a cavity of a mold. Next, the cavity is filled with a composite material containing a magnetic material and a resin so that the exposed parts 14 and 24 (exposed surfaces 140 and 240) are exposed from the mounting surface 41, and the embedded parts 15 and 25 are embedded in the outer core 40. Then, the outer core 40 is molded by compressing and curing the composite material. Thereby, the element body 30 containing the outer core 40 and the inner core 50 is formed. As discussed in above, the coil device 1 shown in FIG. 1 can be manufactured.

As shown in FIG. 2, in the coil device 1 of the present embodiment, in the cross section (ZY cross-section) perpendicular to the mounting surface 41 and the extending direction of the first terminal 13, the first terminal 13 has the maximum thickness at the distal end side which is positioned away from the proximal end of the first terminal 13. Therefore, the surface area of the first terminal 13 expands in proportion to an increase in the thickness of the first terminal 13. Thereby, the first terminal 13 and the element body 30 are coupled strongly, and it is possible to prevent the releasing of the first conductor 10 from the element body 30.

Also, the first terminal 13 gradually becomes thicker towards the distal end of the first terminal 13. Therefore, the thickness increases in a predetermined area of the first terminal 13 which expands the surface area of the first terminal 13. Thereby, the first terminal 13 and the element body 30 can be coupled even more effectively.

Also, the embedded surface 150 is slanted with respect to the exposed surface 140 so that a distance between the embedded surface 150 and the exposed surface 140 widens towards the distal end of the first terminal 13. Thereby, the surface area of the embedded area 150 expands in proportion to the slanted angle of the embedded surface 150, and the first terminal 13 and the element body 30 can be coupled even more effectively.

Also, in the cross-section perpendicular to the mounting surface 41 and the extending direction of the terminal 13, the distal end surface 151 of the first terminal 13 is slanted with respect to the mounting surface 41. Thus, the surface area of the distal end surface 151 expands in proportion to the slanted angle of the distal end surface 151, and the first terminal 13 and the element body 30 can be coupled even more effectively.

Also, the radius of curvature of an inner circumference surface 120 of the first curved part 12 is smaller than the radius of curvature of an outer circumference surface 121 of the first curved part 12. Thus, the first conductor 10 can bend sharply from the first winding part 11 to the first terminal 13. Thereby, for example, when the coil device 1 according to the present embodiment includes the second conductor 20, the distance between the first conductor 10 and the second conductor 20 becomes closer to each other, and magnetic coupling between the first conductor 10 and the second conductor 20 can be enhanced.

The radius of curvature of an inner circumference surface 220 of the second curved part 22 is smaller than the radius of curvature of an outer circumference surface 221 of the second curved portion 22. Thus, the second conductor 20 can easily bend sharply from the second winding part 21 to the second terminal 23. Thereby, the distance between the first conductor 10 and the second conductor 20 becomes closer to each other, and magnetic coupling between the first conductor 10 and the second conductor 20 can be enhanced.

Also, the radius of curvature of the outer circumference surface 221 of the second curved part 22 is larger than the radius of curvature of the outer circumference surface 121 of the first curved part 12. Thus, DC resistance of the second conductor 20 can be reduced.

The present disclosure is not limited to the embodiment described above, and can be modified in various ways within the scope of the present disclosure.

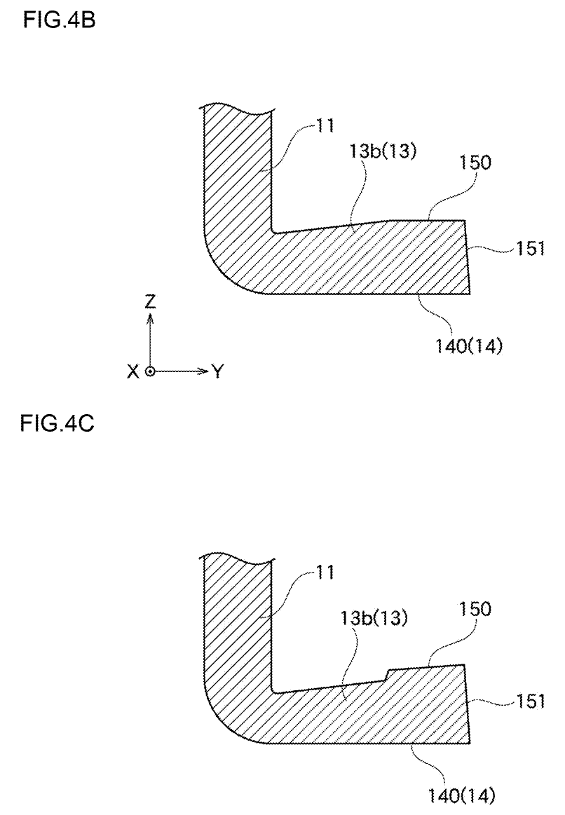

As shown in FIG. 3, in the above embodiment, the slanted angle of the embedded surface 150 with respect to the exposed surface 140 is consistent. However, as shown in FIG. 4A, the slanted angle of the embedded surface 150 with respect to the exposed surface 140 may not be consistent. In the example shown in FIG. 4A, at the distal end side of the first terminal 13, the slanted angle of the embedded surface 150 with respect to exposed surface 140 is smaller compared to the slanted angle at the proximal end side of the first terminal 13. In another embodiment, at the distal end side of the first terminal 13, the slanted angle of the embedded surface 150 with respect to exposed surface 140 may be larger compared to the slanted angle at the proximal end side of the first terminal 13.

Also, as shown in FIG. 3, in the above embodiment, the first terminal 13 gradually becomes thicker from the proximal end to the distal end of the first terminal 13. However, as shown in FIG. 4B, the first terminal 13 may gradually become thicker in part of the area between the proximal end and the distal end of the first terminal 13. In the example shown in FIG. 4B, in at least the proximal end side of the first terminal 13, the first terminal 13 gradually becomes thicker towards the distal end of the first terminal portion 13. In contrast, at least at the distal end side of the first terminal 13, the thickness of the first terminal 13 is consistent.

As shown in FIG. 4C, the first terminal 13 may become thicker in a step-like manner at the distal end side positioned away from the proximal end of the first terminal 13. In this case, the first terminal 13 becomes thicker relatively steeply at the distal end side positioned away from the base of the first terminal 13. Thereby, the first terminal 13 and the element body 30 can be coupled even more effectively.

As shown in FIG. 2, in the above embodiment, the first terminal 13 has the maximum thickness at the distal end side which is positioned away from the proximal end of the first terminal 13. However, in addition to the first terminal 13, the second terminal 23 may have the maximum thickness at the distal end side which is positioned away from the proximal end of the second terminal 23. Alternatively, only the second terminal 23 may be configured to have the maximum thickness at the distal end side which is positioned away from the proximal end of the second terminal 23.

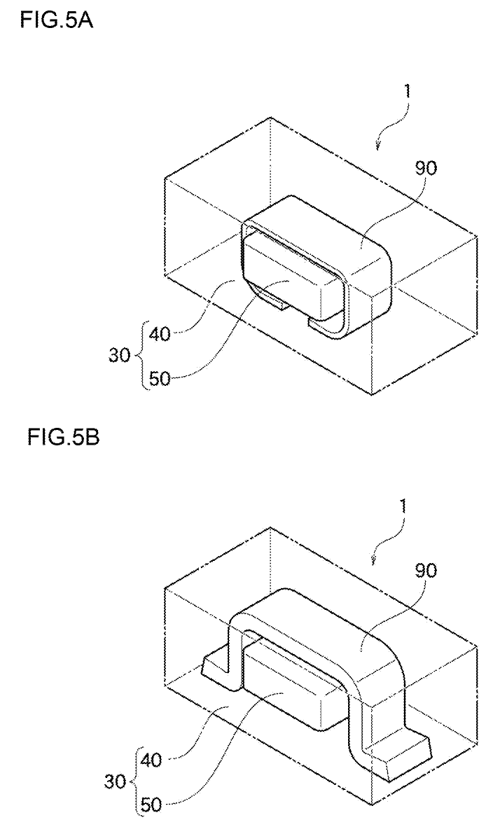

As shown in FIG. 1, in the above embodiment, the coil device 1 includes a pair of conductors, i.e., the first conductor 10 and the second conductor 20. However, the conductors included in the coil device 1 does not necessarily have to be a pair. In addition, the above-described embodiment, the number of pairs of the first conductors 10 and the second conductors 20 is four. However, the number of pairs of the first conductors 10 and the second conductors 20 may be one to three, or five or more. For example, the coil device 1 shown in FIG. 5A is provided with one conductor 90 having a shape similar to that of the second conductor 20 shown in FIG. 1. In addition, the coil device 1 shown in FIG. 5B is provided with one conductor 90 having a shape similar to that of the first conductor 10 shown in FIG. 1.

As shown in FIG. 1, in the above-described embodiment, the element body 30 has two cores, namely, the outer core 40 and the inner core 50. However, the element body 30 may have one core corresponding to the outer core 40.

As shown in FIG. 1, in the above-described embodiment, one inner core 50 is disposed inside the second winding part 21 of each of the second conductors 20_1 to 20_4 so as to penetrate through the interior of the second winding part 21 of each of the second conductors 20_1 to 20_4. However, four inner cores 50 may be disposed inside the respective second winding part 21 of the second conductors 20_1 to 20_4.

The present specification discloses the following.

### Reference note 1

A coil device, including:
an element body containing a magnetic material and a resin, and having a mounting surface; and
a conductor including a winding part embedded in the element body, and a terminal provided at an end of the winding part and extending along the mounting surface;
wherein the terminal has a maximum thickness at a distal end side positioned away from a proximal end of the terminal in a cross section perpendicular to the mounting surface and an extending direction of the terminal.

### Reference note 2

The coil device according to Reference note 1, wherein a thickness of the terminal gradually increases towards a distal end of the terminal.

### Reference note 3

The coil device according to Reference note 1 or 2, wherein the terminal thickens in a step-like manner at the distal end side positioned away from the proximal end of the terminal.

### Reference note 4

The coil device according to any one of Reference notes 1 to 3, wherein the terminal includes an exposed surface exposing from the mounting surface and an embedded surface opposite to the exposed surface and embedded in the element body; and
the embedded surface is slanted with respect to the exposed surface so that a distance between the embedded surface and the exposed surface widens towards the distal end of the terminal.

### Reference note 5

The coil device according to any one of Reference notes 1 to 4, wherein a distal end surface of the terminal is slanted with respect to the mounting surface in the cross-section perpendicular to the mounting surface and the extending direction of the terminal.

### Reference note 6

The coil device according to any one of Reference notes 1 to 5, wherein the conductor comprises a first conductor and a second conductor provided inside the first conductor,
the first conductor includes a first winding part and a first terminal provided at an end of the first winding part and extending along the mounting surface,
the first winding part includes a first curved part curved continuously to the first terminal, and
a radius of curvature of an inner circumference surface of the first curved part is smaller than a radius of curvature of an outer circumference surface of the first curved part.

### Reference note 7

The coil device according to Reference note 6, wherein the second conductor includes a second winding part and a second terminal provided at an end of the second winding part and extending along the mounting surface,
the second winding part includes a second curved part curved continuously to the second terminal, and
a radius of curvature of an inner circumference surface of the second curved part is smaller than a radius of curvature of an outer circumference surface of the second curved part.

### Reference note 8

The coil device according to Reference note 7, wherein the radius of curvature of the outer circumference surface of the second curved part is larger than the radius of curvature of the outer circumference surface of the first curved part.

1...Coil device
10_1 to 10_4...First conductor
11...First winding part
12...First curved part
120...Inner circumference surface
121...Outer circumference surface
13a, 13b...First terminal
14...Exposed part
140...Exposed surface
15...Embedded part
150...Embedded surface
151...Distal end surface
20_1 to 20_4...Second conductor
21...Second winding part
22...Second curved part
220...Inner circumference surface
221...Outer circumference surface
23a, 23b...Second terminal
24...Exposed part
240...Exposed surface
25...Embedded part
250...Embedded surface
251...Distal end surface
30...Element body
40...Outer core
41...Mounting surface
50...Inner core
80...Insulating layer
90...Conductor

What is claimed is:

1. A coil device, comprising:
an element body containing a magnetic material and a resin, and having a mounting surface; and
a conductor including a winding part embedded in the element body, and a terminal provided at an end of the winding part and extending along the mounting surface;
wherein the terminal has a maximum thickness at a distal end side positioned away from a proximal end of the terminal in a cross section perpendicular to the mounting surface and an extending direction of the terminal.

2. The coil device according to claim 1, wherein a thickness of the terminal gradually increases towards a distal end of the terminal.

3. The coil device according to claim 1, wherein the terminal thickens in a step-like manner at the distal end side positioned away from the proximal end of the terminal.

4. The coil device according to claim 1, wherein the terminal comprises an exposed surface exposing from the mounting surface and an embedded surface opposite to the exposed surface and embedded in the element body; and
the embedded surface is slanted with respect to the exposed surface so that a distance between the embedded surface and the exposed surface widens towards the distal end of the terminal.

5. The coil device according to claim 1, wherein a distal end surface of the terminal is slanted with respect to the mounting surface in the cross-section perpendicular to the mounting surface and the extending direction of the terminal.

6. The coil device according to claim 1, wherein the conductor comprises a first conductor and a second conductor provided inside the first conductor,
the first conductor includes a first winding part and a first terminal provided at an end of the first winding part and extending along the mounting surface,
the first winding part includes a first curved part curved continuously to the first terminal, and
a radius of curvature of an inner circumference surface of the first curved part is smaller than a radius of curvature of an outer circumference surface of the first curved part.

7. The coil device according to claim 6, wherein the second conductor includes a second winding part and a second terminal provided at an end of the second winding part and extending along the mounting surface,
the second winding part includes a second curved part curved continuously to the second terminal, and
a radius of curvature of an inner circumference surface of the second curved part is smaller than a radius of curvature of an outer circumference surface of the second curved part.

8. The coil device according to claim 7, wherein the radius of curvature of the outer circumference surface of the second curved part is larger than the radius of curvature of the outer circumference surface of the first curved part.
